(19) United States
(12) Patent Application Publication
(10) Pub. No.: US 2025/0118544 A1
(43) Pub. Date: Apr. 10, 2025

(54) REAGENT FORMULATION FOR MASS AXIS CHECK AND ADJUSTMENT

(71) Applicant: Roche Diagnostics Operations, Inc., Indianapolis, IN (US)

(72) Inventor: Robert Lang, Muenchen (DE)

(21) Appl. No.: 18/694,874

(22) PCT Filed: Sep. 21, 2022
(86) PCT No.: PCT/EP2022/076160

§ 371 Date: Mar. 22, 2024

(30) Foreign Application Priority Data
Sep. 22, 2021 (EP) 21198316.8

(51) Int. Cl. H01J 49/00; G01N 30/02; G01N 30/72

(52) U.S. Cl. CPC H01J 49/0009; G01N 30/7233; G01N 2030/027

(57) ABSTRACT

The present invention relates to a composition comprising (i) cesium iodide, (ii) ethylamine and/or formic acid, and (iii) methanol and/or water. The present invention further relates to a method for calibrating a mass spectrometry (MS) device comprising (I) determining a mass spectrum of a composition as specified; and (II) calibrating the MS device based on the mass spectrum determined in step (I). The present invention further relates to devices, kits, uses, and methods related thereto.

The present invention relates to a composition comprising (i) cesium iodide, (ii) ethylamine and/or formic acid, and (iii) methanol and/or water. The present invention further relates to a method for calibrating a mass spectrometry (MS) device comprising (I) determining a mass spectrum of a composition as specified; and (II) calibrating the MS device based on the mass spectrum determined in step (I). The present invention further relates to devices, kits, uses, and methods related thereto.

In mass spectrometry (MS), proper acquisition of a mass spectrum requires instrument tuning to ensure good sensitivity and peak shape and to ensure that the mass resolution is appropriate for the analytical requirements of the sample. Tuning is followed by mass calibration, i.e. adjusting the m/z scale of the device, which is typically performed by measuring a sample generating peaks at known m/z values and adjusting the m/z axis to reflect the expected values if necessary. Furthermore, usually a background spectrum is measured before analyzing a sample to check for contaminants that may be present in the instrument.

Thus, calibration is a vital part of analytic MS device operation to ensure that correct measurements are obtained. In MS device measurements, in particular in high-throughput settings, it is usually preferred to perform a mass axis check at regular intervals to ensure correct ion identification, and to perform mass axis adjustment if necessary or as a part of routine operation.

Calibration of MS devices has been described, e.g. in US 2018/0047549 A1. Mass axis check and/or adjustment compositions are known in the art as well. E.g. WO 2012/135682 A2 proposes polyethylene compounds and mixtures thereof, in Zhou et al. (2012, Anal Chem 84:6016) cesium iodide was used for calibration. Further, commercial calibration solutions are available: Sciex 6500™ uses two PPG solutions, one for positive ion mode and one for negative ion mode, which have to be stored under controlled, cooled conditions. The Agilent ESI-L Low Concentration Tuning Mix lacks calibrants at around 50 Da. Furthermore, it comprises trifluoroacetic acid ammonium salt, which is known for strong ion suppression in negative mode. The Pierce™ Triple Quadrupole-calibration solution also contains trifluoroacetic acid. Thermo Cascadion™ provides a tyrosine-mix consisting of three species covering the positive ion mode by three m/z points; once open, the vial is only stable for 30 days on the instrument.

Thus, there is still a need in the art for improved means and methods for calibration of MS devices.

This problem is addressed by the composition, methods, device, kit, and use with the features of the independent claims. Advantageous embodiments which might be realized in an isolated fashion or in any arbitrary combinations are listed in the dependent claims.

In accordance, the present invention relates to a composition comprising (i) cesium iodide, (ii) ethylamine and/or formic acid, and (iii) a polar solvent, in an embodiment methanol and/or water.

In general, terms used herein are to be given their ordinary and customary meaning to a person of ordinary skill in the art and, unless indicated otherwise, are not to be limited to a special or customized meaning. As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. Thus, a composition comprising an indicated set of components may in particular consist of the indicated set of components. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements. Also, as is understood by the skilled person, the expressions “comprising a” and “comprising an” in an embodiment refer to “comprising one or more”, i.e. are equivalent to “comprising at least one”. In accordance, expressions relating to one item of a plurality, unless otherwise indicated, in an embodiment relate to at least one such item, in a further embodiment a plurality thereof, thus, e.g. determining “a spectrum” relates to identifying at least one spectrum, in an embodiment to determining a multitude of spectra.

Further, as used in the following, the terms “preferably”, “more preferably”, “most preferably”, “particularly”, “more particularly”, “specifically”, “more specifically” or similar terms are used in conjunction with optional features, without restricting further possibilities. Thus, features introduced by these terms are optional features and are not intended to restrict the scope of the claims in any way. The invention may, as the skilled person will recognize, be performed by using alternative features. Similarly, features introduced by “in an embodiment” or similar expressions are intended to be optional features, without any restriction regarding further embodiments of the invention, without any restrictions regarding the scope of the invention and without any restriction regarding the possibility of combining the features introduced in such way with other optional or non-optional features of the invention.

The methods specified herein below, in an embodiment, are in vitro methods. The method steps may, in principle, be performed in any arbitrary sequence deemed suitable by the skilled person, but in an embodiment are performed in the indicated sequence; also, one or more, in an embodiment all, of said steps may be assisted or performed by automated equipment. Moreover, the methods may comprise steps in addition to those explicitly mentioned above.

As used herein, the term “standard conditions”, if not otherwise noted, relates to IUPAC standard ambient temperature and pressure (SATP) conditions, i.e. in an embodiment, a temperature of 25° C. and an absolute pressure of 100 kPa; also in an embodiment, standard conditions include a pH of 7. Moreover, if not otherwise indicated, the term “about” relates to the indicated value with the commonly accepted technical precision in the relevant field, in an embodiment relates to the indicated value ±20%, in a further embodiment ±10%, in a further embodiment ±5%. Further, the term “essentially” indicates that deviations having influence on the indicated result or use are absent, i.e. potential deviations do not cause the indicated result to deviate by more than ±20%, in a further embodiment ±10%, in a further embodiment ±5%. Thus, “consisting essentially of” means including the components specified but excluding other components except for materials present as impurities, unavoidable materials present as a result of processes used to provide the components, and components added for a purpose other than achieving the technical effect of the invention. For example, a composition defined using the phrase “consisting essentially of” encompasses any known acceptable additive, excipient, diluent, carrier, and the like. In an embodiment, a composition consisting essentially of a set of components will comprise less than 5% by weight, in a further embodiment less than 3% by weight, in a further embodiment less than 1% by weight, in a further embodiment less than 0.1% by weight of non-specified component(s).

The term “composition”, as used herein, relates to each and every composition of matter comprising the indicated compounds. In an embodiment, the composition comprises the indicated compounds, in a further embodiment, the composition essentially consists of the indicated compounds, in a further embodiment, the composition consists of the indicated compounds. In an embodiment, the composition is a liquid composition, in a further embodiment, the composition is liquid under standard conditions as specified herein above. In an embodiment, the composition comprises ethylamine and formic acid; in a further embodiment the polar solvent comprises, in an embodiment consists of, methanol and water. Thus, in an embodiment, the composition comprises (i) cesium iodide, (ii) ethylamine and/or formic acid, and (iii) methanol and/or water; thus, in an embodiment, the composition comprises (i) cesium iodide, (ii) ethylamine, and (iii) methanol; in a further embodiment comprises (i) cesium iodide, (ii) ethylamine, and (iii) water; in a further embodiment comprises (i) cesium iodide, (ii) ethylamine, and (iii) methanol and water; in a further embodiment comprises (i) cesium iodide, (ii) formic acid, and (iii) methanol; in a further embodiment comprises (i) cesium iodide, (ii) formic acid, and (iii) water; in a further embodiment comprises (i) cesium iodide, (ii) formic acid, and (iii) methanol and water; in a further embodiment comprises (i) cesium iodide, (ii) ethylamine and formic acid, and (iii) methanol; in a further embodiment comprises (i) cesium iodide, (ii) ethylamine and formic acid, and (iii) water; in a further embodiment comprises (i) cesium iodide, (ii) ethylamine and formic acid, and (iii) methanol and water. In an embodiment, the composition further comprises Cyclosporine A, 5-(4-Hydroxyphenyl)-5-phenylhydantoin, and/or ammonium formate. Thus, the composition may comprise, in an embodiment consist of, any of the aforesaid compound compositions and further may comprise Cyclosporine A, 5-(4-Hydroxyphenyl)-5-phenylhydantoin, ammonium formate, Cyclosporine A and 5-(4-Hydroxyphenyl)-5-phenylhydantoin, Cyclosporine A and ammonium formate, 5-(4-Hydroxyphenyl)-5-phenylhydantoin and ammonium formate, or Cyclosporine A, 5-(4-Hydroxyphenyl)-5-phenylhydantoin, and ammonium formate. Thus, in an embodiment, the composition comprises, preferably consists of, cesium iodide, ethylamine, formic acid, Cyclosporine A, 5-(4-Hydroxyphenyl)-5-phenylhydantoin, ammonium formate, methanol and water. In an embodiment, the composition comprises the indicated components at the concentrations specified herein. Unless otherwise indicated, the polar solvent being present at the highest concentration, in an embodiment water, is added to 100%. Thus, in an embodiment, the composition may be produced by pre-mixing all components except the polar solvent being present at the highest concentration, and filling up to 100% with polar solvent being present at the highest concentration; thus, in an embodiment, any share in the composition not accounted for is the polar solvent being present at the highest concentration, in an embodiment water. As is understood by the skilled person, the term “concentration of X is to 100%” relates to an addition of compound X in an amount to provide for a volume required for the other compounds of the composition to have the desired concentrations. In an embodiment, the purity of the components of the composition is independently selected from at least 90%, in an embodiment at least 95%, in a further embodiment at least 98%, in a further embodiment at least 99%, at least 99.5%, in a further embodiment at least 99.9%. Typical impurities of the respective components of the composition are known to the skilled person. In an embodiment, the composition is stable for at least 1 month, in an embodiment at least 2 months, in a further embodiment at least 6 months, in a further embodiment at least 12 months, in a further embodiment at least 18 months, under standard conditions, in an embodiment at a temperature of 35° C., in a further embodiment at a temperature of 50° C., in a further embodiment under conditions preventing evaporation. In an embodiment, in particular in case the concentration of methanol is less than 15% (v/v), the composition is sterilized.

In a further embodiment, the composition comprises (i) CsI and methanol and/or comprises (ii) CsI and water. Thus, the present invention also relates to a composition comprising cesium iodide and a polar solvent, in an embodiment methanol and/or water, in an embodiment with properties as specified elsewhere herein. Also, the present invention relates to the devices, kits, methods, and uses as specified elsewhere herein comprising the aforesaid composition or the use thereof. The aforesaid composition may in particular be used in applications in which mass axis adjustment and/or mass axis check in the m/z range of from 300 to 2000 is desired.

In an embodiment, the composition is a calibration composition, in an embodiment a mass spectrometry (MS) calibration composition, in a further embodiment an MS calibration solution. The term “calibration” is used herein in a broad sense in concurrence with typical use by the skilled person. Thus, the term calibration includes an operation which establishes under specified conditions a relation between quantity values obtained with measurement standards and corresponding quantity values of a calibrated instrument, i.e. a calibration sensu stricto. Calibration may, however, also be verification of measurement values. The term calibration further includes measures of adjusting or re-adjusting the calibrated instrument or its output to concur with the aforesaid quantity values obtained with measurement standards, i.e. calibration in its usual, broader sense. Thus, calibration may in particular be mass axis check (MAC) and/or mass axis adjustment (MAA), in an embodiment in mass spectrometry. In an embodiment, the composition is a universal calibration solution for positive ion mode and for negative ion mode MS. In an embodiment, in case the calibration composition comprises at least ethylamine, formic acid, and cesium iodide, and at least one of methanol and water, the m/z values of the main signals are, in positive ion mode: 46, 133, 393, 653, 912, 1172, 1432, 1692, and/or 1952, in an embodiment are 46.066, 132.905, 392.715, 652.524, 912.334, 1172.144, 1431.953, 1691.763, and/or 1951.572, and in negative ion mode: 45, 127, 387, 647, 906, 1166, 1426, 1686, and/or 1946, in an embodiment 44.998, 126.905, 386.714, 646.524, 906.333, 1166.143, 1425.953, 1685.762, and/or 1945.572. In an embodiment, the composition further comprises at least one of Cyclosporine A, 5-(4-Hydroxyphenyl)-5-phenylhydantoin, and ammonium formate, and m/z values of resulting additional ions are 601.921, 1202.841, 1219.841, 1224.841, 1334.751, and 269.0848 in positive ion mode, and 267.0848 and 1200.841 in negative ion mode. Thus, in an embodiment, calibration is calibration in the m/z range of from 46 to 1952 in positive ion mode, and/or is calibration in the m/z range of from 45 to 1946 in positive ion mode. In an embodiment, the composition is a calibration use solution, i.e. a solution to be used for direct injection into an MS device; in such case, in an embodiment, the concentration of (i) cesium iodide is of from 0.1 μg/mL to 10 mg/mL; (ii) ethylamine, if present, is of from 0.01 μg/mL to 0.1 mg/mL; formic acid, if present, is of from 0.001% (v/v) to 1% (v/v); and (iii) the polar solvent, in an embodiment methanol, water, or a mixture thereof, is to 100%. In a further embodiment, the composition is a tenfold concentrated calibration stock solution, i.e. a solution to be used for injection into an MS device after tenfold dilution; in such case, in an embodiment, the concentration of (i) cesium iodide is of from 1 μg/mL to 100 mg/mL; (ii) ethylamine, if present, is of from 0.1 μg/mL to 1 mg/mL; formic acid, if present, is of from 0.01% (v/v) to 10% (v/v); and (iii) the polar solvent, in an embodiment methanol, water, or a mixture thereof, is to 100%. As will be understood, other stock solutions can be derived by the skilled person, e.g. twofold or fivefold concentrated stock solutions. As will also be understood, the term “stock solution” does not necessarily imply that the composition has to be diluted before use. Thus, depending on the application, the sensitivity of the specific device, and other parameters taken into account by the skilled person, the composition may also be used undiluted or less diluted; e.g. a tenfold stock solution may only be diluted twofold or fivefold before use. Also, the composition may be more diluted, e.g. a tenfold stock solution may e.g. be diluted 100fold before use; in an embodiment, the final concentration of the compound(s) is at least as specified herein below even after such overdilution. In case a stock solution is diluted, it is in an embodiment diluted with a polar solvent as specified herein below. Thus, the stock solution may in particular be diluted with water, methanol, acetonitrile, or any mixture of any of the aforesaid, in particular a mixture of methanol and acetonitrile, acetonitrile and water, or a mixture of water and methanol. In a further embodiment, the composition is diluted with methanol or a mixture of water and methanol. In view of the description herein below, the molar ratio of cesium iodide: ethylamine (if present): formic acid (if present) in the composition may be in a range of (1-20):(1-5):(1000-1500), in an embodiment is about 9: about 1: about 1207, in an embodiment is 9:1:1207.

As used herein in the context of the composition as specified, the term “stable” relates to the property of the composition continuing to be suitable for use in calibration, in particular in mass axis adjustment and/or calibration in mass spectrometry (MS), at least for the indicated period of time. Thus, in an embodiment, in a stable composition at least 10%, in a further embodiment at least 25%, in a further embodiment at least 50%, in a further embodiment at least 75%, in a further embodiment at least 85%, in a further embodiment at least 90%, of the initial MS signal is still obtainable after 18 months at 50° C. if measured under the same MS conditions. In a further embodiment, the term stable relates to the property of the composition of providing signal intensity >2.5e5 cps in Q1 and Q3 in positive and negative mode for all target m/z, in an embodiment the target m/z as specified herein above, in an embodiment after storage under conditions and time frames as specified herein above.

The term “cesium iodide” is understood by the skilled person; the CAS NO. of CsI is 7789-17-5 and the molar mass is 259.809 g/mol. In an embodiment, the concentration of cesium iodide in the composition is of from 0.1 μg/mL to 100 mg/mL; in a further embodiment the concentration of cesium iodide in the composition is of from 1 μg/mL to 10 mg/mL, in a further embodiment of from 5 μg/mL to 5 mg/mL, in a further embodiment of from 10 μg/mL to 1 mg/mL. In an embodiment, the concentration of cesium iodide in the composition is about 500 μg/mL, in an embodiment is 500 μg/mL in a tenfold concentrated stock solution, and/or is about 50 μg/mL, in an embodiment is 50 μg/mL in a use solution. Thus, the concentration of cesium iodide in the composition may be of from 0.38 μM to 0.38 M, in an embodiment is about 1.9 mM in a tenfold concentrated stock solution and/or about 0.19 mM in a use solution.

The term “ethylamine” is also understood by the skilled person to relate to ethanamine, CAS NO. 75-04-7, with a molar mass of 45.085 g/mol. In an embodiment, the concentration of ethylamine in the composition is of from 0.01 μg/mL to 1 mg/mL; in a further embodiment, the concentration of ethylamine in the composition is of from 0.05 μg/mL to 0.5 mg/mL, in a further embodiment 0.2 μg/mL to 0.1 mg/mL, in a further embodiment 0.5 μg/mL to 25 μg/mL. In an embodiment, the concentration of ethylamine in the composition is about 10 μg/mL, in an embodiment is 10 μg/mL in a tenfold concentrated stock solution, and/or is about 1 μg/mL, in an embodiment is 1 μg/mL in a use solution. Thus, the concentration of ethylamine in the composition may be of from 0.22 μM to 22 mM, in an embodiment is about 0.22 mM in a tenfold concentrated stock solution and/or about 0.022 mM in a use solution.

“Formic acid” is also referred to as methanoic acid, and has a molar mass of 46.025 g/mol and CAS NO. 64-18-6. In an embodiment, the concentration of formic acid in the composition is of from 0.001% (v/v) to 10% (v/v); in a further embodiment, the concentration of formic acid in the composition is of from 0.005% (v/v) to 7.5% (v/v), in a further embodiment of from 0.01% (v/v) to 5% (v/v), in a further embodiment of from 0.05% (v/v) to 2% (v/v). In an embodiment, the concentration of formic acid in the composition is about 1% (v/v), in an embodiment is 1% (v/v), in a tenfold concentrated stock solution, and/or is about 0.1% (v/v), in an embodiment is 0.1% (v/v) in a use solution. Thus, the concentration of formic acid in the composition may be of from 0.27 mM to 2.7 M, in an embodiment is about 0.27 M in a tenfold concentrated stock solution and/or about 27 mM in a use solution.

The term “methanol” is understood by the skilled person; the CAS NO. is 67-56-1 and the molar mass is 32.04 g/mol. The concentration of methanol may, in principle, be to 100%; i.e., the other compounds of the composition may, in principle, be provided and methanol be added to fill up to 100%. Methanol may, however, also be absent from the composition; in such case, in an embodiment, water is added to 100%. Thus, in an embodiment, the concentration of methanol in the composition is of from 0% (v/v) to 100% (v/v) in the polar solvent used to fill the composition up to 100%. In an embodiment, the concentration of methanol in the composition is of from 10% (v/v) to 50% (v/v), in a further embodiment of from 15% (v/v) to 40% (v/v). In an embodiment, the concentration of methanol in the composition is about 30% (v/v), in a further embodiment is 30% (v/v). In a further embodiment, the concentration of methanol in the composition may be about 25% (v/v), in a further embodiment may be 25% (v/v).

The CAS NO. of water is 7732-18-5, its molar mass is 18.015 g/mol. In an embodiment, water is distilled water, in a further embodiment is double distilled water, in a further embodiment is p.a. water.

The term “Cyclosporine A” is known to the skilled person to relate to (3S,6S,9S,12R,15S,18S,21S,24S,30S,33S)-30-Ethyl-33-[(1R,2R,4E)-1-hydroxy-2-methyl-4-hexen-1-yl]-6,9,18,24-tetraisobutyl-3,21-diisopropyl-1,4,7,10,12,15,19,25,28-nonamethyl-1,4,7,10,13,16,19,22,25,28,31-undecaazacyclotritriacontane-2,5,8,11,14,17,20,23,26,29,32-undecone, CAS NO. 59865-13-3, with a molar mass of 1202.61 g/mol. In an embodiment, the concentration of Cyclosporine A in the composition is of from 0.01 μg/mL to 1000 μg/mL; in a further embodiment, the concentration of Cyclosporine A in the composition is of from 0.1 μg/mL to 1000 μg/mL, in a further embodiment of from 0.5 μg/mL to 500 μg/mL, in a further embodiment of from 1 μg/mL to 50 μg/mL, in a further embodiment of from 5 μg/mL to 25 μg/mL. In an embodiment, the concentration of Cyclosporine A in the composition is about 10 μg/mL, in an embodiment is 10 μg/mL in a tenfold concentrated stock solution and/or is about 1 μg/mL, in an embodiment is 1 μg/mL, in a use solution. Thus, the concentration of Cyclosporine A in the composition may be about 8.3 μM in a tenfold concentrated stock solution and/or about 0.83 μM in a use solution.

The term “5-(4-Hydroxyphenyl)-5-phenylhydantoin” is known to the skilled person to relate to 5-(4-Hydroxyphenyl)-5-phenyl-2,4-imidazolidinedione, CAS NO. 2784-27-2, with a molar mass of 268.27 g/mol. In an embodiment, the concentration of 5-(4-Hydroxyphenyl)-5-phenylhydantoin in the composition is of from 0.01 μg/mL to 1000 μg/mL, in a further embodiment of from 0.5 μg/mL to 500 μg/mL, in a further embodiment of from 1 μg/mL to 50 μg/mL, in a further embodiment of from 5 μg/mL to 25 μg/mL. In an embodiment, the concentration of 5-(4-Hydroxyphenyl)-5-phenylhydantoin in the composition is about 10 μg/mL, in a further embodiment is 10 μg/mL in a tenfold concentrated stock solution and/or is about 1 μg/mL, in an embodiment is 1 μg/mL, in a use solution. Thus, the concentration of 5-(4-Hydroxyphenyl)-5-phenylhydantoin in the composition may be about 37 μM in a tenfold concentrated stock solution and/or about 3.7 μM in a use solution. The term “ammonium formate” is known to the skilled person. The CAS NO. of the compound is 540-69-2, the molar mass is 63.06 g/mol. In an embodiment, the concentration of ammonium formate in the composition is of from 0.01 mM to 1 M. In a further embodiment, the concentration of ammonium formate in the composition is of from 0.05 mM to 500 mM, in a further embodiment of from 0.1 mM to 50 mM, in a further embodiment of from 0.25 mM to 10 mM. In an embodiment, the concentration of ammonium formate in the composition is about 5 mM, in an embodiment is 5 mM, in a tenfold concentrated stock solution, and/or is about 0.5 mM, in an embodiment is 0.5 mM, in a use solution.

The term “polar solvent” is understood by the skilled person. Preferably, the term relates to a solvent or mixture of solvents having a dipole moment of at least 1.5 D, preferably at least 1.7 D. Preferably, the polar solvent is methanol, water, ethanol, acetonitrile, n-propanol, isopropanol, or a mixture of any combination of at least two of the aforesaid polar solvents. More preferably, the polar solvent is methanol, water, or a mixture thereof. Particularly envisaged mixtures of methanol and water are specified elsewhere herein.

Advantageously, it was found in the work underlying the present invention that the compositions described herein are useful as universal calibration solutions suitable for use in positive as well as negative ion mode, providing the option to calibrate over a broad range of m/z values, and providing a suitable number of calibration points over the whole range. Moreover, the solution is stable even at elevated temperatures, i.e. conditions which may prevail in a typical MS device for at least one year.

The definitions made above apply mutatis mutandis to the following. Additional definitions and explanations made further below also apply for all embodiments described in this specification mutatis mutandis.

The present invention further relates to a method for calibrating a mass spectrometry (MS) device comprising
(I) determining a mass spectrum of a composition as specified herein above; and
(II) calibrating the MS device based on the mass spectrum determined in step (I).

The term calibration has been specified herein above. In an embodiment, calibrating is performing a mass axis check and/or a mass axis adjustment. As specified herein above, in an embodiment, calibration is calibration in the m/z range of from 46 to 1952 in positive ion mode, and/or is calibration in the m/z range of from 45 to 1946 in negative ion mode, with specific calibration point indicated herein above. In an embodiment, non-identical ions generated from the composition are used in mass axis check vs. mass axis adjustment, i.e., in an embodiment, mass axis adjustment is performed with a first set of ions and mass axis check is performed with a second set of ions, wherein said first set of ions is non-identical to said second set of ions. In an embodiment, ions comprised in the first set of ions are not comprised in the second set of ions, and vice versa. In an embodiment, ions generated from Cyclosporine A and/or 5-(4-Hydroxyphenyl)-5-phenylhydantoin are used optionally in mass axis check, and are, in a further embodiment, not used in mass axis adjustment.

In an embodiment, calibrating is performing a mass axis check (MAC), i.e. is verifying that the mass axis is correctly adjusted. Said mass axis check, in an embodiment, comprises determining a mass spectrum of a composition as specified herein and verifying that for at least two, in an embodiment at least three, in a further embodiment at least five, in a further embodiment all of the m/z ratios indicated above signals are obtained within a pre-specified acceptance range. In case the m/z ratios are obtained within said pre-specified range, the method may indicate that mass axis check was passed successfully, in an embodiment followed by termination of the method. In case at least one of the m/z ratios is not obtained within said pre-specified range, the method may indicate that mass axis check failed and may terminate; in such case, the method, may, however, also continue to perform steps of mass axis adjustment as specified herein below.

In an embodiment, calibrating is performing a mass axis adjustment (MAA), i.e. is adjusting or re-adjusting at least one parameter of an MS device such that the m/z values measured for at least one, in an embodiment at least two, in an embodiment at least three, in a further embodiment at least five, in a further embodiment all of the m/z ratios indicated above, are obtained within a pre-specified acceptance range. The parameters adjustable to achieve the aforesaid mass axis adjustment are known to the skilled person and include hardware parameters, e.g. instrument tuning, including e.g. radio frequency digital to analog converter (RF DAC) and/or direct current (DC) factor settings, as well as software parameters, e.g. m/z axis adjustment, and the like.

The term “mass spectrometry device”, abbreviated as “MS device”, is understood by the skilled person. In an embodiment, the term relates to a device configured for performing a mass spectrometry (MS); thus, the device, in an embodiment, comprises at least one MS unit. As used herein, the term “mass spectrometry unit”, in an embodiment, relates to a mass analyzer configured for detecting at least one analyte based on a mass to charge ratio of the analyte or a fragment thereof. In an embodiment, the MS unit is single MS unit, in an embodiment is a tandem mass spectrometry (MS/MS) unit, in a further embodiment a triple quadrupole MS (QqQ-MS), in a further embodiment in Multiple Reaction Monitoring (MRM) mode. In case the MS device is a triple quadrupole MS, in an embodiment the second mass analyzer is calibrated by the method specified. The MS device may further comprise at least one ionization source configured for generating molecular ions and for transferring the molecular ions into the gas phase. Ionization methods and appropriate ionization units are known in the art and include in particular electron ionization (EI), chemical ionization (CI), electrospray ionization (ESI), atmospheric pressure ionization (APCI), atmospheric pressure photoionization (APPI), and matrix assisted laser desorption/ionization (MALDI).

In an embodiment, the MS device is a chromatography MS device, in particular a gas chromatography MS (GC-MS) device or a liquid chromatography MS (LC-MS) device, terms understood by the skilled person. Thus, in an embodiment, the device is configured for performing a combination of chromatography (e.g. LC or GC)) with mass spectrometry (MS). Thus, the device, in an embodiment, comprises at least one LC and/or GC unit, and at least one MS unit, wherein the LC and/or GC unit(s) and the MS unit are coupled via at least one interface. As used herein, the term “liquid chromatography (LC) unit”, in an embodiment, relates to an analytical module configured to separate one or more analytes of interest of a sample from other components of the sample via liquid chromatography, in an embodiment for detection of the one or more analytes with the mass spectrometry device. The LC may be based on any separation principle deemed appropriate by the skilled person; in an embodiment, the LC is reverse phase chromatography, hydrophobic interaction chromatography, ion exchange chromatography, size exclusion chromatography, affinity chromatography, or chiral chromatography; in a further embodiment, the LC is reverse phase chromatography. The LC device may comprise at least one LC column. For example, the LC device may be a single-column LC device or a multi-column LC device having a plurality of LC columns. The LC column may have a stationary phase through which a mobile phase is pumped in order to separate and/or elute and/or transfer the analyte(s) of interest. The LC unit may be or may comprise at least one high-performance liquid chromatography (HPLC) unit and/or at least one micro liquid chromatography (μLC) device. The term “gas chromatography” is understood by the skilled person; in an embodiment the same separation principles as for LC are applicable, however, the mobile phase being a gas in GC.

The term “determining a mass spectrum” is understood by the skilled person. In an embodiment, the term relates to determining a correlation plot of a semiquantitative or quantitative measure of one or more signals obtained from a sample by an MS detector with the m/z value of the ions causing said signals. A graphical representation of a mass spectrum may be provided e.g. as a centroid graph and/or as a continuum graph. In an embodiment, a mass spectrum is described by the parameters m/z peak position, m/z peak resolution, m/z peak signal intensity and m/z peak shape for at least one peak.

The present invention also relates to a device comprising the composition as specified herein above.

The term “device”, as used herein, relates to a system of means comprising at least the aforementioned means operatively linked to each other, in an embodiment to allow a calibration to be made. Typical means for calibration are known to the skilled person and are disclosed above in connection with the methods of the invention, thus, the device may be adapted to perform at least one method specified herein. In accordance, the device in an embodiment comprises, optionally tangibly embedded e.g. in a data carrier or memory unit comprised in the device, an executable code which, when executed, causes the device to perform at least one method specified herein or one or more step thereof, in an embodiment the method for calibrating an MS device. How to link the means of the device in an operating manner will depend on the type of means included into the device. In an embodiment, the means are comprised by a single device. Said device may accordingly include (i) an analyzing unit for the measurement of the compounds comprised in the composition and (ii) a storage unit for storing the composition. In an embodiment, the storage unit and the analyzing unit are connected by fluid connectors, e.g. tubing, to allow transfer of the composition to the analyzing unit. Further optional units may be e.g. a memory unit, a data carrier unit, a data interface unit, an output unit, and the like. The person skilled in the art will realize how to provide and link appropriate means without further ado. The results may be given as output of raw data which need interpretation by a technician. In an embodiment, the output of the device is, however, processed, i.e. evaluated, raw data, the interpretation of which does not require a technician. In an embodiment, the device is an MS device as specified herein above, in particular an MS/MS device.

The instant invention also relates to a kit comprising (i) cesium iodide; (ii) ethylamine and/or formic acid; and (iii) methanol, water, or a mixture thereof; in a housing.

The term “kit”, as used herein, refers to a collection of the aforementioned compounds, means or reagents which may or may not be packaged together. The components of the kit may be comprised by separate vials (i.e. as a kit of separate parts) or provided in a single vial, e.g. as a composition as specified herein above. The housing of the kit in an embodiment allows translocation of the compounds of the kit, in particular common translocation; thus, the housing may in particular be a transportable container comprising all specified components. Moreover, it is to be understood that the kit of the present invention may be used for practicing the methods referred to herein above. It is, in an embodiment, envisaged that all components are provided in a ready-to-use manner for practicing the methods referred to above. Further, the kit, in an embodiment, contains instructions for carrying out said methods. The instructions can be provided by a user's manual in paper- or electronic form. For example, the manual may comprise instructions for interpreting the results obtained when carrying out the aforementioned methods using the kit.

In an embodiment, the kit comprises (i) cesium iodide; (ii) ethylamine and formic acid; and (iii) methanol, water, or a mixture thereof; or comprises (i) cesium iodide; (ii) ethylamine and formic acid; and (iii) a mixture of water and methanol. In a further embodiment, the kit further comprises at least one, in an embodiment at least two, in a further embodiment all three compound(s) selected from the list consisting of Cyclosporine A, 5-(4-Hydroxyphenyl)-5-phenylhydantoin, and ammonium formate. In an embodiment, the kit comprises cesium iodide as a solid and ethylamine, formic acid, methanol and/or water as a pre-mixed liquid. In an embodiment, the kit comprises (i) CsI in methanol and/or (ii) CsI in water. In a further embodiment, the components of the kit are comprised in the kit as solutions having at least the concentrations as specified herein above. In a further embodiment, the kit further comprises a polar solvent as specified herein above as a diluent, in a further embodiment comprises methanol.

The present invention also relates to a use of a composition as specified herein, a method as specified herein, a device as specified herein, and/or a kit as specified herein; for calibrating a mass spectrometry device.

The present invention moreover relates to a method for manufacturing a mass spectrometry calibration solution comprising admixing the compounds as specified herein above, thereby manufacturing a mass spectrometry calibration solution.

The method for manufacturing a mass spectrometry calibration solution may comprise further steps, such as providing the compounds specified, in an embodiment at the required concentration or the required amount, dissolving solid components, adjusting the volume of the calibration solution, filtering and/or sterilizing the calibration solution, or any other further step or steps deemed appropriate by the skilled person.

The invention further discloses and proposes a computer program including computer-executable instructions for performing the method according to the present invention in one or more of the embodiments enclosed herein when the program is executed on a computer or computer network, in an embodiment on an MS device. Specifically, the computer program may be stored on a computer-readable data carrier. Thus, specifically, one, more than one or even all of method steps as indicated above may be controlled and/or performed by using a computer or a computer network, in an embodiment an MS device, in an embodiment by using a computer program. It is, thus, envisaged that the method of calibrating an MS device may be executed as a (sub) routine of an MS device. Said execution may be manual, manually triggered, may be automatically triggered, e.g. after a pre-defined number of analyses or upon a change of analytical protocol, or may be performed automatically in its entirety. Thus, the device and/or the computer program may additionally comprise a database of m/z values expected upon analysis of the composition.

The invention further discloses and proposes a computer program product having program code means, in order to perform the method according to the present invention in one or more of the embodiments enclosed herein when the program is executed on a computer or computer network, in an embodiment on an MS device. Specifically, the program code means may be stored on a computer-readable data carrier.

Further, the invention discloses and proposes a data carrier having a data structure stored thereon, which, after loading into a computer or computer network, such as into a working memory or main memory of the computer or computer network, in an embodiment an MS device, may execute the method according to one or more of the embodiments disclosed herein.

The invention further proposes and discloses a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier. Specifically, the computer program product may be distributed over a data network.

Finally, the invention proposes and discloses a modulated data signal which contains instructions readable by a computer system or computer network, in an embodiment an MS device, for performing the method according to one or more of the embodiments disclosed herein.

In an embodiment, referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network, in an embodiment by an MS device. Generally, these method steps may include any of the method steps, typically except for method steps requiring manual work, such as providing samples and/or certain aspects of performing the actual measurements.

Specifically, the present invention further discloses:
A computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

Summarizing the findings of the present invention, the following embodiments are particularly envisaged:

Embodiment 1: A composition comprising (i) cesium iodide, (ii) ethylamine and/or formic acid, and (iii) a polar solvent, in an embodiment methanol and/or water.

Embodiment 2: The composition of embodiment 1, wherein the concentration of
(i) cesium iodide is of from 0.1 μg/mL to 100 mg/mL;
(ii) ethylamine, if present, is of from 0.01 μg/mL to 1 mg/mL formic acid, if present, is of from 0.001% (v/v) to 10% (v/v)
(iii) the polar solvent, in an embodiment methanol, water, or a mixture thereof, is to 100%.

Embodiment 3: The composition of embodiment 1 or 2, wherein the concentration of cesium iodide is about 50 μg/mL, in an embodiment is 50 μg/mL, or is about 500 μg/mL, in an embodiment is 500 μg/mL.

Embodiment 4: The composition of any one of embodiments 1 to 3, wherein the concentration of ethylamine, if present, is about 1 μg/mL, in an embodiment is 1 μg/mL, or about 10 μg/mL, in an embodiment is 10 μg/mL.

Embodiment 5: The composition of any one of embodiments 1 to 4, wherein the concentration of formic acid, if present, is about 0.1% (v/v), in an embodiment is 0.1% (v/v), or about 1% (v/v), in an embodiment is 1% (v/v).

Embodiment 6: The composition of any one of embodiments 1 to 5, wherein the concentration of methanol, if present, is of from 15% (v/v) to 90% (v/v) and of water is to 100%.

Embodiment 7: The composition of any one of embodiments 1 to 6, wherein said composition comprises ethylamine and formic acid.

Embodiment 8: The composition of any one of embodiments 1 to 7, wherein said composition further comprises Cyclosporine A at a concentration of from 0.01 μg/mL to 1000 μg/mL.

Embodiment 9: The composition of any one of embodiments 1 to 8, wherein said composition further comprises 5-(4-Hydroxyphenyl)-5-phenylhydantoin at a concentration of from 0.01 μg/mL to 1000 μg/mL.

Embodiment 10: The composition of any one of embodiments 1 to 9, wherein said composition further comprises ammonium formate at a concentration of from 0.01 mM to 1 M.

Embodiment 11: The composition of any one of embodiments 1 to 10, wherein said composition is stable for at least 1 month, in an embodiment at least 6 months, in a further embodiment at least 12 months, in a further embodiment at least 18 months under standard conditions.

Embodiment 12: The composition of any one of embodiments 1 to 11, wherein said composition is stable for at least 1 month, in an embodiment at least 6 months, in a further embodiment at least 12 months, in a further embodiment at least 18 months at a temperature of 50° C.

Embodiment 13: The composition of any one of embodiments 1 to 12, wherein the purity of the components of the composition is independently selected from at least 90%, in an embodiment at least 95%, in a further embodiment at least 98%, in a further embodiment at least 99%, at least 99.5%, in a further embodiment at least 99.9%.

Embodiment 14: The composition of any one of embodiments 1 to 13, wherein said composition is a mass spectrometry (MS) calibration solution.

Embodiment 15: The composition of any one of embodiments 1 to 14, wherein said composition is a universal calibration solution for positive mode and for negative mode MS.

Embodiment 16: A method for calibrating a mass spectrometry (MS) device comprising
(I) determining a mass spectrum of a composition according to any one of embodiments 1 to 15; and
(II) calibrating the MS device based on the mass spectrum determined in step (I).

Embodiment 17: The method of embodiment 16, wherein said calibrating is checking mass axis and/or adjusting mass axis.

Embodiment 18: The method of embodiment 16 or 17, wherein said MS device is a tandem MS device.

Embodiment 19: The method of any one of embodiments 16 to 18, wherein said calibration is calibration in an m/z range of from 50 Da to 2000 Da.

Embodiment 20: The method of any one of embodiments 16 to 19, wherein said calibration comprises establishing at least two calibration points selected from m/z values selected for positive ion mode from the list consisting of 46, 133, 393, 653, 912, 1172, 1432, 1692, and/or 1952, and for negative ion mode from the list consisting of 45, 127, 387, 647, 906, 1166, 1426, 1686, and/or 1946.

Embodiment 21: A device comprising the composition according to any one of embodiments 1 to 15.

Embodiment 22: The device of embodiment 21, wherein said device is a mass spectrometry (MS) device.

Embodiment 23: The device of embodiment 21 or 22, wherein said device is a tandem mass spectrometry (MS/MS) device.

Embodiment 24: The device of any one of embodiments 21 to 23, wherein said device is adapted to perform the method of any one of embodiments 16 to 20.

Embodiment 25: The device of embodiment 21 to 24, wherein said device comprises, in an embodiment tangibly embedded, an executable code which, when executed, causes the device to perform the method according to any one of embodiments 16 to 20.

Embodiment 26: A kit comprising (i) cesium iodide; (ii) ethylamine and/or formic acid; and (iii) methanol, water, or a mixture thereof; in a housing.

Embodiment 27: The kit of embodiment 26, wherein said kit comprises (i) cesium iodide; (ii) ethylamine and formic acid; and (iii) methanol, water, or a mixture thereof.

Embodiment 28: The kit of embodiment 26 or 27, wherein said kit comprises (i) cesium iodide; (ii) ethylamine and formic acid; and (iii) a mixture of water and methanol.

Embodiment 29: The kit of any one of embodiments 26 to 28, wherein said kit further comprises at least one, in an embodiment at least two, in a further embodiment all three compound(s) selected from the list consisting of Cyclosporine A, 5-(4-Hydroxyphenyl)-5-phenylhydantoin, and ammonium formate.

Embodiment 30: The kit of any one of embodiments 26 to 29, wherein said kit comprises cesium iodide as a solid and ethylamine, formic acid, methanol and/or water as a pre-mixed liquid.

Embodiment 31: The kit of any one of embodiments 26 to 30, wherein the components of the kit are comprised in the kit as solutions having at least the concentrations as specified in any one of embodiments 2 to 10.

Embodiment 32: Use of a composition according to any one of embodiments 1 to 15, a method according to any one of embodiments 16 to 20, a device according to any one of embodiments 21 to 25, and/or a kit according to any one of embodiments 26 to 31; for calibrating a mass spectrometry device.

Embodiment 33: A method for manufacturing a mass spectrometry calibration solution comprising admixing the compounds according to any one of embodiments 1 to 15, thereby manufacturing a mass spectrometry calibration solution.

Embodiment 34: A composition comprising
cesium iodide at a concentration of about 500 μg/mL, in an embodiment 500 μg/mL;
ethylamine at a concentration of about 10 μg/mL, in an embodiment 10 μg/mL;
formic acid at a concentration of about 1% (v/v), in an embodiment of 1% (v/v); and
30% methanol in water;
wherein, in an embodiment, said composition is a tenfold concentrated stock solution.

Embodiment 35: The composition of embodiment 34, further comprising at least one, in an embodiment at least two, in a further embodiment all, further compounds selected from the group consisting of
Cyclosporine A at a concentration of about 10 μg/mL, in an embodiment of 10 μg/mL;
5-(4-Hydroxyphenyl)-5-phenylhydantoin at a concentration of about 10 μg/mL, in an embodiment of 10 μg/mL; and
Ammonium formate at a concentration of about 5 mM, in an embodiment 5 mM.

Embodiment 36: A composition comprising
cesium iodide at a concentration of about 50 μg/mL, in an embodiment 50 g/mL;
ethylamine at a concentration of about 1 μg/mL, in an embodiment 1 μg/mL;
formic acid at a concentration of about 0.1% (v/v), in an embodiment of 0.1% (v/v); and
a polar solvent, in an embodiment 30% methanol in water;
wherein, in an embodiment, said composition is a onefold concentrated use solution.

Embodiment 37: The composition of embodiment 36, further comprising at least one, in an embodiment at least two, in a further embodiment all, further compounds selected from the group consisting of
Cyclosporine A at a concentration of about 1 μg/mL, in an embodiment of 1 μg/mL;
5-(4-Hydroxyphenyl)-5-phenylhydantoin at a concentration of about 1 μg/mL, in an embodiment of 1 μg/mL; and
Ammonium formate at a concentration of about 0.5 mM, in an embodiment 0.5 mM.

Embodiment 38: A composition comprising
cesium iodide at a concentration of about 500 μg/mL, in an embodiment 500 μg/mL;
ethylamine at a concentration of about 10 μg/mL, in an embodiment 10 μg/mL;
formic acid at a concentration of about 1% (v/v), in an embodiment of 1% (v/v);
Cyclosporine A at a concentration of about 10 μg/mL, in an embodiment of 10 μg/mL;
5-(4-Hydroxyphenyl)-5-phenylhydantoin at a concentration of about 10 μg/mL, in an embodiment of 10 μg/mL;
Ammonium formate at a concentration of about 5 mM, in an embodiment 5 mM; and
30% methanol in water;
wherein, in an embodiment, said composition is a tenfold concentrated stock solution.

Embodiment 39: A composition comprising
cesium iodide at a concentration of about 50 μg/mL, in an embodiment 50 μg/mL;
ethylamine at a concentration of about 1 μg/mL, in an embodiment 1 μg/mL;
formic acid at a concentration of about 0.1% (v/v), in an embodiment of 0.1% (v/v);
Cyclosporine A at a concentration of about 1 μg/mL, in an embodiment of 1 μg/mL;
5-(4-Hydroxyphenyl)-5-phenylhydantoin at a concentration of about 1 μg/mL, in an embodiment of 1 μg/mL;
Ammonium formate at a concentration of about 0.5 mM, in an embodiment 0.5 mM; and
a polar solvent, in an embodiment 30% methanol in water;
wherein, in an embodiment, said composition is a onefold concentrated use solution.

Embodiment 40. A composition comprising cesium iodide and a polar solvent.

Embodiment 41. The composition of embodiment 40, having at least one feature of a composition of any one of embodiments 1 to 15.

Embodiment 42. A method according to any one of embodiments 16 to 20 and 33, a device according to any one of embodiments 21 to 25, a kit according to any one of embodiments 26 to 31, and/or a use according to embodiment 32, comprising or making use of a composition according to embodiment 40 or 41.

All references cited in this specification are herewith incorporated by reference with respect to their entire disclosure content and the disclosure content specifically mentioned in this specification.

The following Examples shall merely illustrate the invention. They shall not be construed, whatsoever, to limit the scope of the invention.

### Example 1: Preparation of Calibration Solutions

A 10× stock solution consisting of the following ingredients was prepared:
Ethylamine (10 μg/mL)
Formic acid (1% (v/v))
Cesium iodide (500 μg/mL)
Methanol (30% (v/v) in water ad 100%.

The origin (manufacturer and product Nos) are shown in Table 1 below; exemplary amounts used for producing 5 L and 0.5 L of the 10× stock solution are provided in Table 2; further parameters are shown in Table 3.

TABLE 1
Origin of chemicals.

| compound | manufacturer | product no. |
|---|---|---|
| Formic acid ≥99% (FA) | Fisher Chemical | A117-50 |
| Ethylamine in H2O 66-72% (EA) | Sigma Aldrich | 471208 |
| Cesium Iodide (CsI) | Sigma Aldrich | 21004 |
| ULC/MS grade Methanol (MeOH) | Fisher Chemical | A456-1 |
| LC/MS grade H2O | From Milli-Q-system | N/A |

TABLE 2
Amounts for producing 0.5 L of 10× stock solution

| | target | | amount for | | | |
|---|---|---|---|---|---|---|
| compound | concentration | | 0.5 L | unit | V-% | W-% |
| FA (≥99%) | 1.0% | (v/v) | 5.05 | mL | 1.0% | 1.314% |
| EA (66-72%) | 10.0 | μg/mL | 0.0089 | mL | 0.0018% | 0.0015% |
| CsI | 500.0 | μg/mL | 0.25 | g | | 0.0533% |
| MeOH | 30% | (v/v) | 150 | mL | 30% | 25.3% |
| H2O | 69% | (v/v) | 344.941 | mL | 69% | 73.3% |
| | | | 500.0000 | mL | 100.0% | 100.0% |

TABLE 3
Further parameters of the 10× stock solution produced according
to Table 2.

| compound | MW [g/mol] | concentration [mM] | mol-% |
|---|---|---|---|
| FA | 46.03 | 268 | 0.584% |
| EA | 45.08 | 0.22 | 0.0005% |
| CsI | 259.81 | 1.92 | 0.0042% |
| MeOH | 32.04 | | 16.2% |
| H2O | 18.02 | | 83.3% |
| | | | 100.0% |

Further 10× stock solutions additionally comprising the following were prepared:
Cyclosporine A (10 μg/mL);
5-(4-Hydroxyphenyl)-5-phenylhydantoin (10 μg/mL)
Ammonium formate (5 mM)

### Example 2: Identification of Calibrator Ions

The compositions of Example 1 were diluted tenfold with methanol (10% of the respective composition and 90% of methanol (v/v)), infused at 30 μL/min by a single cylinder pump into the ESI source and measured on a ESI-MS-MS instrument in positive ion mode and negative ion mode. The ions identified were:

In positive ion mode: 46.066, 132.905, 392.715, 652.524, 912.334, 1172.144, 1431.953, 1691.763, and/or 1951.572.

In negative ion mode: 44.998, 126.905, 386.714, 646.524, 906.333, 1166.143, 1425.953, 1685.762, and/or 1945.572.

In the presence of Cyclosporine A, 5-(4-Hydroxyphenyl)-5-phenylhydantoin, and ammonium formate, the following additional ions were identified:

In positive ion mode: 601.921, 1202.841, 1219.841, 1224.841, 1334.751, and 269.0848.

In negative ion mode: 267.0848 and 1200.841.

Thus, the very low m/z range (˜50 Da) is covered in positive and negative ion mode, respectively. Also, CsI covers the m/z range from approx. 100 to 2000 Da in positive and negative ion by cluster formation. This combination allows for MAC/MAA in a very broad m/z range (50-2000 Da) leading to higher reliability of measurements. In addition, CsI provides m/z calibration points every 200-300 Da increasing mass axis accuracy. CsI clusters can be fragmented and therefore be used for MAC/MAA in product ion scan which allows lower CsI concentration. Fragments of CsI clusters can also be used for system monitoring.

Further ingredients such as Cyclosporine A and 5-(4-Hydroxyphenyl)-5-phenylhydantoin provide the possibility for system monitoring. Furthermore, such compounds can be fragmented in product ion scan mode. Resulting fragments can be used for MAC/MAA in Q3 and hence further reduce reagent complexity. Thus, the aforesaid further ingredients may in particular be used to monitor ESI-MS/MS parameters such as gas flow, ESI voltage, and voltage along the MS/MS ion path. In particular the aforesaid compounds have the further advantage of being stable for at least 18 months even at increased temperature, such as 37° C. or 50° C., that they do not interfere with the signals obtained from the other components of the composition, that they are bipolar, i.e. can be ionized in negative ion mode and in positive ion mode, that they can be fragmented on appropriate devices, and have the propensity of forming adducts, in particular with Na—, Cs— and/or ammonium ions.

### Example 3: Stability

The solutions of Example 1 were stored at room temperature, 35° C. or at 50° C. for up to 18 months with decrease in signal intensity being below 60% compared to the initial signal.

### Literature Cited

US 2018/0047549 A1
WO 2012/135682 A2
Zhou et al. (2012, Anal Chem 84:6016)

1. A composition comprising (i) cesium iodide, (ii) ethylamine and/or formic acid, and (iii) methanol and/or water.

2. The composition of claim 1, comprising (i) cesium iodide, (ii) ethylamine, and (iii) methanol and/or water.

3. The composition of claim 1, wherein the concentration of
(i) cesium iodide is of from 1 μg/mL to 100 mg/mL;
(ii) ethylamine, if present, is of from 0.1 μg/mL to 1 mg/mL formic acid, if present, is of from 0.01% (v/v) to 10% (v/v)
(iii) methanol, water, or a mixture thereof is to 100%.

4. The composition of claim 1, wherein the concentration of cesium iodide is 500 μg/mL, wherein the concentration of ethylamine, if present, is 10 μg/mL, wherein the concentration of formic acid, if present, is 1% (v/v), and/or wherein the concentration of methanol is 25% (v/v) and wherein water is added to 100%.

5. The composition of claim 1, wherein said composition comprises cesium iodide, ethylamine, formic acid, methanol, and water.

6. The composition of claim 1, wherein said composition further comprises Cyclosporine A at a concentration of from 0.1 μg/mL to 1000 μg/mL.

7. The composition of claim 1, wherein said composition further comprises 5-(4-Hydroxyphenyl)-5-phenylhydantoin at a concentration of from 0.1 μg/mL to 1000 μg/mL.

8. The composition of claim 1, wherein said composition further comprises ammonium formate at a concentration of from 0.1 mM to 1 M.

9. The composition of claim 1, wherein said composition is a universal calibration solution for positive mode and for negative mode MS.

10. A method for calibrating a mass spectrometry (MS) device comprising:
(I) determining a mass spectrum of a composition according to 1; and
(II) calibrating the MS device based on the mass spectrum determined in step (I).

11. The method of claim 10, wherein said calibrating is checking mass axis and/or adjusting mass axis.

12. The method of claim 10, wherein said calibration comprises establishing at least two calibration points selected from m/z values selected for positive ion mode from the list consisting of 46, 133, 393, 653, 912, 1172, 1432, 1692, and/or 1952, and for negative ion mode from the list consisting of 45, 127, 387, 647, 906, 1166, 1426, 1686, and/or 1946.

13. (canceled)

14. A kit comprising (i) cesium iodide; (ii) ethylamine and/or formic acid; and (iii) methanol, water, or a mixture thereof; in a housing.

15. (canceled)

16. A method for manufacturing a mass spectrometry calibration solution comprising admixing the compounds according to claim 1, thereby manufacturing a mass spectrometry calibration solution.
